(19) United States
(12) Patent Application Publication
(10) Pub. No.: US 2026/0077703 A1
(43) Pub. Date: Mar. 19, 2026

(54) Apparatus and System for Securing Overhanging Loads on a Vehicle

(71) Applicant: Michael M Hagan, Cornelius, NC (US)

(72) Inventor: Michael M Hagan, Cornelius, NC (US)

(21) Appl. No.: 18/885,722

(22) Filed: Sep. 15, 2024

(51) Int. Cl. B60P 7/08

(52) U.S. Cl. CPC B60P 7/0876; B60P 7/0823

(57) ABSTRACT

An apparatus and system for securing elongated cargo extending beyond a vehicle bed. The apparatus comprises a flexible net with perpendicular webbing straps forming a grid structure. Reinforced loops extend from the net perimeter, and adjustable tie-down straps couple the loops to the vehicle bed. A central attachment point mounts a signalling device. The system restrains overhanging cargo against the bed, preventing loss during transport. The net and straps are removably coupled, allowing easy installation, removal, and storage. The invention provides an effective solution for securing loads inadequately retained by conventional restraints, enhancing safety and reducing cargo loss risk.

### BACKGROUND OF THE INVENTION

### Field of Invention

The present invention relates to the field of cargo restraint systems for vehicles, particularly for securing elongated loads that extend beyond the cargo area of a vehicle.

### Description of Prior Art

Cargo nets and restraints are commonly used to secure loads in vehicles such as pickup trucks. However, problems exist with securing elongated cargo that is longer than the bed of the truck and overhangs the rear of the vehicle. Conventional cargo nets are not well-suited for such loads, as they do not adequately retain the overhanging portion of the cargo. This can lead to the cargo becoming unsecured during transport, posing a risk of loss and creating potential safety hazards.

Accordingly, there is a need in the art for an improved cargo restraint system that effectively secures elongated loads extending beyond the cargo area of a vehicle, while being easily deployable and storable when not in use.

### BRIEF SUMMARY OF THE INVENTION

This summary is provided to introduce a selection of concepts, in a simplified format, that are further described in the detailed description of the invention. This summary is neither intended to identify key or essential inventive concepts of the invention nor is it intended for determining the scope of the invention.

The present invention addresses the need for an improved cargo restraint system capable of effectively securing elongated loads that extend beyond the cargo area of a vehicle. The invention provides an apparatus for securing an overhanging load on a vehicle, comprising a cargo net formed by a plurality of horizontal straps and vertical straps knitted together, wherein the horizontal straps are longer than the vertical straps. A reinforced cable is sewn into top and bottom edges of uppermost and lowermost horizontal straps of the cargo net, the reinforced cable extending outwardly from each side of the cargo net to form attachment points. A plurality of secondary straps, each having a first end configured to engage one of the attachment points and a second end configured to engage a mounting point on the vehicle, allow the cargo net to be secured to the vehicle, thereby restraining the overhanging load.

In another embodiment, the invention provides a system for securing elongated cargo extending beyond a bed of a vehicle. The system comprises a flexible net having a grid structure formed by perpendicular sets of webbing straps, the net being sized to cover a portion of the elongated cargo overhanging the bed. Reinforced loops extend from a perimeter of the flexible net, and a central attachment point on the flexible net is adapted to mount a signalling device. A set of adjustable tie-down straps, each having a first end adapted to engage one of the reinforced loops and a second end adapted to couple to the bed of the vehicle, anchor the flexible net to the vehicle, wherein the flexible net is configured to retain the overhanging portion of the elongated cargo against the bed, and the adjustable tie-down straps are configured to anchor the flexible net to the vehicle.

In a preferred embodiment, the cargo net of the apparatus comprises three horizontal straps and nine vertical straps, wherein the horizontal straps are approximately twice as long as the vertical straps. The reinforced cable of the apparatus loops back to an opposing edge of the cargo net after extending outwardly to form the attachment points. A central attachment point comprising a carabiner may be attached to the straps of the cargo net, adapted to mount a signalling device such as a red flag for indicating an extended and overhanging load.

In one embodiment, the secondary straps of the apparatus are removably coupled to the attachment points and the mounting points on the vehicle, allowing for easy installation and removal. The cargo net and secondary straps are detachable from the vehicle and storable when not in use, providing convenience and versatility.

In an embodiment of the system, the perpendicular sets of webbing straps comprise a plurality of horizontal straps and a plurality of vertical straps, the horizontal straps being longer than the vertical straps. A reinforced cable is sewn into upper and lower edges of the flexible net, the reinforced cable extending outwardly from each side of the flexible net to form the reinforced loops. The reinforced cable is configured to loop back from the reinforced loops to an opposing edge of the flexible net.

In another embodiment of the system, the central attachment point comprises a carabiner attached to the perpendicular sets of webbing straps, and a signaling flag is adapted to be mounted to the carabiner for indicating an overhanging load. The adjustable tie-down straps are configured to be detachable from the reinforced loops and the bed of the vehicle.

In a further embodiment of the system, a plurality of securing mounts are positioned in the bed of the vehicle, the second end of each adjustable tie-down strap being adapted to couple to one of the securing mounts. The elongated cargo may comprise a plurality of planar materials longer than a length of the bed, and the flexible net is configured to hook over an end of the planar materials.

In operation, the flexible net of the system is configured to hook over the end of planar materials such as lumber that overhang the bed of the vehicle. The adjustable tie-down straps couple to securing mounts positioned in the bed of the vehicle, anchoring the net and securing the overhanging portion of the elongated cargo against the bed. The apparatus and system of the present invention provide the benefit of securing elongated cargo that conventional restraints cannot adequately address, solving the problems associated with inadequate retention of overhanging loads, enhancing safety, and reducing the risk of cargo loss during transport. When not in use, the flexible net and the adjustable tie-down straps are configured to be detached and stored. These and other features and advantages of the invention will be more fully understood from the following detailed description of the preferred embodiments, taken together with the accompanying drawings.

This revised detailed description incorporates the exact claim language in embodiment paragraph form, ensuring that all claims are fully supported in the specification. The key aspects of each claim are described in the context of the invention's embodiments, providing a clear and comprehensive disclosure of the invention's scope and features. Additional features and advantages of the invention will be set forth in the description which follows, and in part will be obvious from the description, or may be learned by the practice of the invention. These and other features of the present invention will become more fully apparent from the following description, or may be learned by the practice of the invention as set forth hereinafter.

### BRIEF DESCRIPTION OF THE DRAWINGS

The various exemplary embodiments of the present invention, which will become more apparent as the description proceeds, are described in the following detailed description in conjunction with the accompanying drawings, in which:

FIG. 1 depicts an aerial view of the main component of the system for securing elongated cargo extending beyond a bed of a vehicle, according to one embodiment.

FIG. 2 depicts the cargo net system in use, securing a load of elongated cargo such as a plurality of planar materials, according to one embodiment.

FIG. 3 depicts another perspective view of the cargo net system in use is provided, according to one embodiment.

FIG. 4 illustrates a close-up view of the securing mount located in the bed of the pickup truck, according to one embodiment.

FIG. 5 presents a perspective view of an alternative use for the cargo net system with a pickup truck, according to one embodiment.

### DETAILED DESCRIPTION

In the following detailed description of the preferred embodiments, reference is made to the accompanying drawings, which form a part hereof and show, by way of illustration, specific embodiments in which the invention may be practiced. It is to be understood that other embodiments may be used and structural or logical changes may be made without departing from the scope of the present invention. The following detailed description, therefore, is not to be taken in a limiting sense, and the scope of the present invention is defined by the appended claims.

The following description is provided as an enabling teaching of the present systems, and/or methods in its best, currently known aspect. To this end, those skilled in the relevant art will recognize and appreciate that many changes can be made to the various aspects of the present systems described herein, while still obtaining the beneficial results of the present disclosure. It will also be apparent that some of the desired benefits of the present disclosure can be obtained by selecting some of the features of the present disclosure without utilizing other features.

Accordingly, those who work in the art will recognize that many modifications and adaptations to the present disclosure are possible and can even be desirable in certain circumstances and are a part of the present disclosure. Thus, the following description is provided as illustrative of the principles of the present disclosure and not in limitation thereof.

The terms “a” and “an” and “the” and similar references used in the context of describing a particular embodiment of the present invention (especially in the context of certain claims) are construed to cover both the singular and the plural. The recitation of ranges of values herein is merely intended to serve as a shorthand method of referring individually to each separate value falling within the range. Unless otherwise indicated herein, each individual value is incorporated into the specification as if it were individually recited herein.

All systems described herein can be performed in any suitable order unless otherwise indicated herein or otherwise clearly contradicted by context. The use of any and all examples, or exemplary language (for example, “such as”) provided with respect to certain embodiments herein is intended merely to better illuminate the application and does not pose a limitation on the scope of the application otherwise claimed. No language in the specification should be construed as indicating any non-claimed element essential to the practice of the application. Thus, for example, reference to “an element” can include two or more such elements unless the context indicates otherwise.

As used herein, the terms “optional” or “optionally” mean that the subsequently described event or circumstance can or cannot occur, and that the description includes instances where said event or circumstance occurs and instances where it does not.

The word or as used herein means any one member of a particular list and also includes any combination of members of that list. Further, one should note that conditional language, such as, among others, “can,” “could,” “might”, or “may” unless specifically stated otherwise, or otherwise understood within the context as used, is generally intended to convey that certain aspects include, while other aspects do not include, certain features, elements and/or steps. Thus, such conditional language is not generally intended to imply that features, elements and/or steps are in any way required for one or more particular aspects or that one or more particular aspects necessarily include logic for deciding, with or without user input or prompting, whether these features, elements and/or steps are included or are to be performed in any particular aspect.

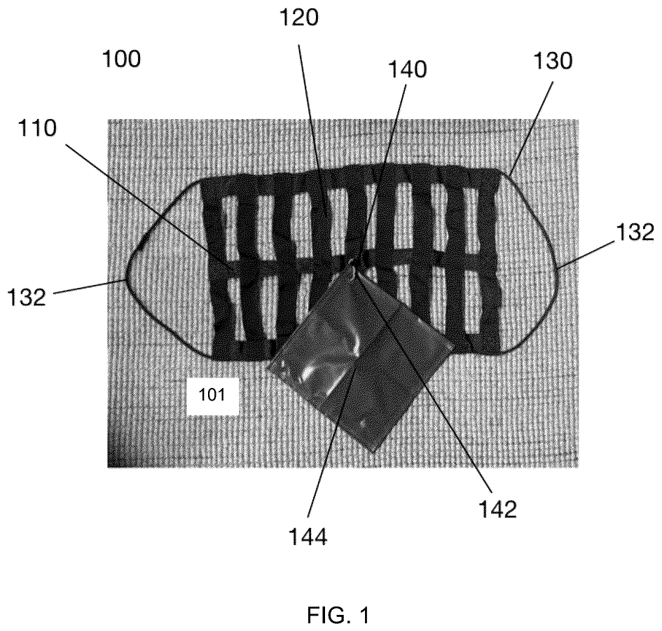

With reference to FIGS. 1-3, an embodiment of an apparatus for securing an overhanging load on a vehicle, particularly a cargo net system for use with a pickup truck (100), is illustrated.

As shown in FIG. 1, in one embodiment, the cargo net system (100) comprises a cargo net (101) formed by a plurality of webbing straps knitted together in a grid pattern. In the illustrated embodiment, the cargo net (101) includes three horizontal strap (110) and nine vertical strap (120), wherein the horizontal strap (110) are generally twice as long or longer than the vertical strap (120). The cargo net (101) further comprises a reinforced cable (130) sewn into the top and bottom edges of the uppermost and lowermost horizontal strap (110). As depicted, the reinforced cable (130) extends outwardly from each side of the cargo net (101) to form attachment points (132) for further securing the cargo net (101) to the vehicle. After extending outwardly to form the attachment points (132), the reinforced cable (130) loops back to the opposing top or bottom edge of the cargo net (101).

In some embodiments, disposed at the centre of the cargo net (101) is a central attachment point (140) where a carabiner (142) is coupled to the straps. The carabiner (142) is configured to allow for the attachment of a red signaling flag (144) to indicate an extended and overhanging load.

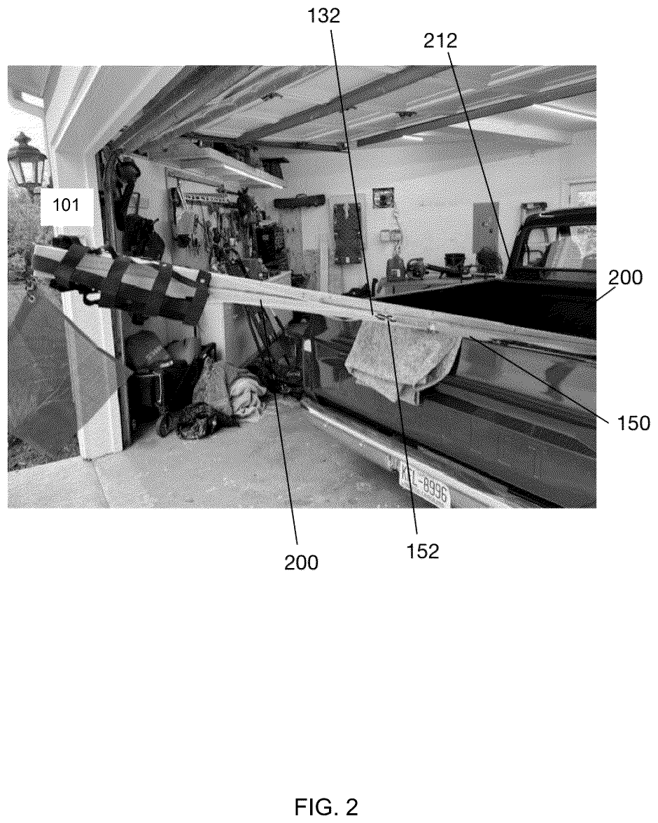

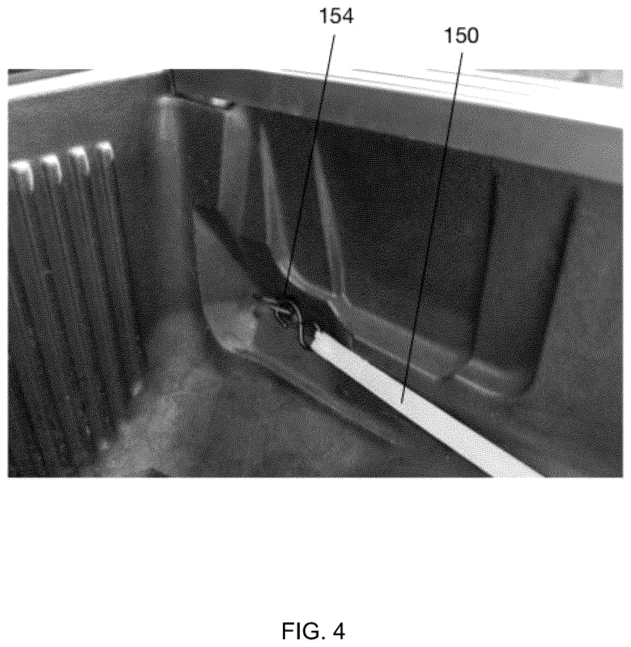

Turning to FIG. 2, a perspective view depicting an embodiment of the cargo net system (100) in use is provided. As illustrated, the cargo net (101) is shown hooked over the end of multiple elongated planar materials, which may include, but are not limited to, 2×4 wooden planks (200) overhanging the back of a pickup truck (210). In this configuration, the planks (200) are longer than the bed (212) of the pickup truck (210), thereby necessitating the use of the cargo net system (100) to secure the overhanging portion. The cargo net system (100) further comprises two adjustable tie-down straps (150) coupled to the attachment points (132) on the sides of the cargo net (101) via hooks (152). The other end of each tie-down strap (150) is configured to couple to a securing mount (154) (See FIG. 4) disposed in the bed (212) of the pickup truck (210), thereby anchoring the cargo net (101) to the vehicle.

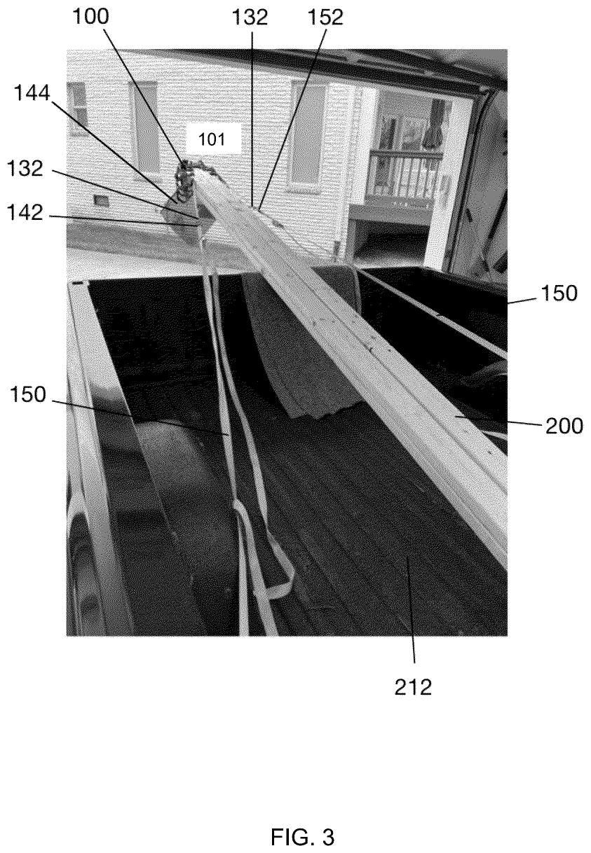

With reference to FIG. 3, another perspective view of an embodiment of the cargo net system (100) in use is depicted, as seen from the front of the pickup truck bed (212) proximate to the cabin. This view further illustrates how the 2×4 wooden planks (200) are secured at the rear of the pickup truck (210) by the cargo net (101). As shown, the adjustable tie-down straps (150) extend from the attachment points (132) on the cargo net (101) to the securing mounts (214) in the bed (212), thereby holding the cargo net (101) taut over the overhanging portion of the planks (200).

In one embodiment, the cargo net (101), along with the adjustable tie-down straps (150), can be easily detached from the vehicle and stored when not in use. The hooks (152) on the tie-down straps (150) are configured to allow for quick attachment and removal from the attachment points (132) on the cargo net (101) and the securing mounts (154) in the pickup truck bed (212). This configuration provides convenient storage and versatility for the cargo net system (100) when not needed for hauling oversize loads.

In summary, the cargo net system (100) depicted in FIGS. 1-3 provides a secure and adaptable solution for transporting elongated cargo that extends beyond the bed of a pickup truck. The combination of the grid-patterned cargo net (101) with reinforced attachment points (132) and adjustable tie-down straps (150) ensures that overhanging loads are properly restrained during transport. Moreover, the inclusion of the central attachment point (140) for a signaling flag (144) adds an important safety feature to alert other drivers of the extended load. As a result, this cargo net system (100) offers a practical and effective method for securing oversize cargo while maintaining vehicle safety and ease of use.

FIG. 4 illustrates a close-up view of the securing mount (154) located in the bed of the pickup truck. The securing mount (154) is configured to receive and securely attach to the hooks of the adjustable tie-down straps (150). This connection point ensures that the cargo net remains taut and properly secured to the vehicle, preventing the overhanging load from shifting during transport.

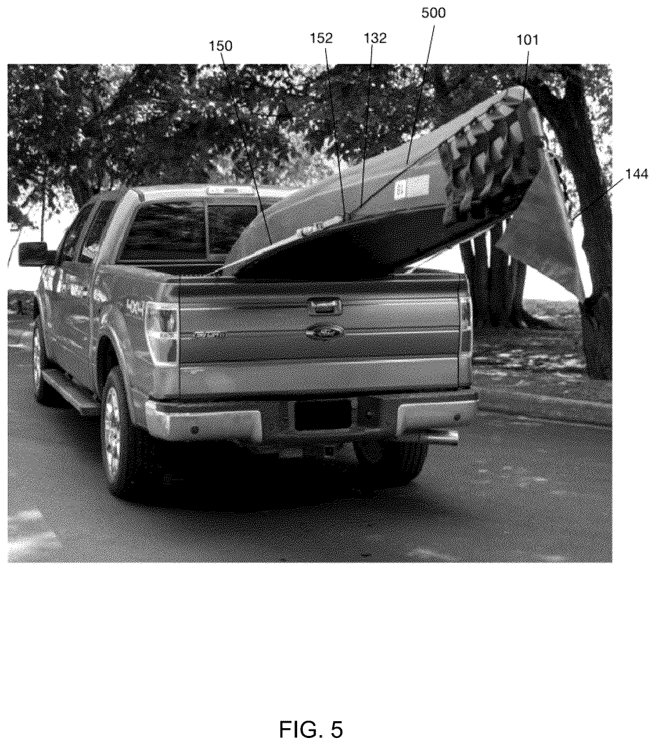

FIG. 5 presents a perspective view of an alternative use for the cargo net (101) with a pickup truck with a flag (144). In this embodiment, the cargo net is shown securing a canoe (500) that extends beyond the length of the bed. The canoe (500) is positioned on top of the cargo net, which is hooked over the rear end of the canoe (500). The adjustable tie-down straps (150) are coupled to the attachment points (132) on the sides of the cargo net via hooks (152) and extend to the securing mounts in the bed, similar to the configuration depicted in FIG. 2.

The embodiments described herein are given for the purpose of facilitating the understanding of the present invention and are not intended to limit the interpretation of the present invention. The respective elements and their arrangements, materials, conditions, shapes, sizes, or the like of the embodiment are not limited to the illustrated examples but may be appropriately changed. Further, the constituents described in the embodiment may be partially replaced or combined together.

What is claimed is:

1. An apparatus for securing an overhanging load on a vehicle, comprising:
a cargo net formed by a plurality of horizontal straps and vertical straps knitted together, wherein the horizontal straps are longer than the vertical straps;
a reinforced cable sewn into top and bottom edges of uppermost and lowermost horizontal straps of the cargo net, the reinforced cable extending outwardly from each side of the cargo net to form attachment points; and
a plurality of secondary straps, each having a first end configured to engage one of the attachment points and a second end configured to engage a mounting point on the vehicle, wherein the cargo net is adapted to hook over an end of the overhanging load, and the secondary straps are adapted to secure the cargo net to the vehicle, thereby restraining the overhanging load.

2. The apparatus of claim 1, wherein the cargo net comprises three horizontal straps and nine vertical straps.

3. The apparatus of claim 1, wherein the horizontal straps are approximately twice as long as the vertical straps.

4. The apparatus of claim 1, wherein the reinforced cable loops back to an opposing edge of the cargo net after extending outwardly to form the attachment points.

5. The apparatus of claim 1, further comprising a central attachment point on the cargo net adapted to mount a signaling device.

6. The apparatus of claim 4, wherein the central attachment point comprises a carabiner attached to the straps of the cargo net.

7. The apparatus of claim 4, wherein the signaling device is a red flag for indicating an extended and overhanging load.

8. The apparatus of claim 1, wherein the secondary straps are removably coupled to the attachment points and the mounting points on the vehicle.

9. The apparatus of claim 1, wherein the cargo net and secondary straps are detachable from the vehicle and storable when not in use.

10. The apparatus of claim 1, wherein the vehicle is a pickup truck and the mounting points are located in a bed of the pickup truck.

11. A system for securing elongated cargo extending beyond a bed of a vehicle, comprising:
a flexible net having a grid structure formed by perpendicular sets of webbing straps, the net being sized to cover a portion of the elongated cargo overhanging the bed;
reinforced loops extending from a perimeter of the flexible net; a central attachment point on the flexible net adapted to mount a signaling device; and
a set of adjustable tie-down straps, each having a first end adapted to engage one of the reinforced loops and a second end adapted to couple to the bed of the vehicle, wherein the flexible net is configured to retained the overhanging portion of the elongated cargo against the bed, and the adjustable tie-down straps are configured to anchor the flexible net to the vehicle.

12. The system of claim 11, wherein the perpendicular sets of webbing straps comprise a plurality of horizontal straps and a plurality of vertical straps, the horizontal straps being longer than the vertical straps.

13. The system of claim 11, further comprising a reinforced cable sewn into upper and lower edges of the flexible net, the reinforced cable extending outwardly from each side of the flexible net to form the reinforced loops.

14. The system of claim 12, wherein the reinforced cable is configured to loop back from the reinforced loops to an opposing edge of the flexible net.

15. The system of claim 11, wherein the central attachment point comprises a carabiner attached to the perpendicular sets of webbing straps.

16. The system of claim 14, further comprising a signaling flag adapted to be mounted to the carabiner for indicating an overhanging load.

17. The system of claim 11, wherein the adjustable tie-down straps are configured to be detachable from the reinforced loops and the bed of the vehicle.

18. The system of claim 11, further comprising a plurality of securing mounts positioned in the bed of the vehicle, the second end of each adjustable tie-down strap being adapted to couple to one of the securing mounts.

19. The system of claim 11, wherein the elongated cargo comprises a plurality of planar materials longer than a length of the bed, and wherein the flexible net is configured to hook over an end of the planar materials.

20. The system of claim 11, wherein the flexible net and the adjustable tie-down straps are configured to be detached and stored when not in use.
